(19) United States
(12) Patent Application Publication
(10) Pub. No.: US 2025/0329762 A1
(43) Pub. Date: Oct. 23, 2025

(54) COOLING CONTROL METHOD AND COOLING CONTROL DEVICE FOR FUEL CELL STACKS

(71) Applicants: TOYOTA JIDOSHA KABUSHIKI KAISHA, Toyota-shi (JP); DENSO CORPORATION, Kariya-city (JP)

(72) Inventors: Tsuyoshi MARUO, Okazaki-shi (JP); Ryosuke YAMADA, Kariya-shi (JP); Shunjiro KIKAWA, Kariya-shi (JP)

(73) Assignees: TOYOTA JIDOSHA KABUSHIKI KAISHA, Toyota-shi (JP); DENSO CORPORATION, Kariya-city (JP)

(21) Appl. No.: 19/052,536

(22) Filed: Feb. 13, 2025

(30) Foreign Application Priority Data
Apr. 22, 2024 (JP) 2024-068907

(51) Int. Cl. H01M 8/04746; H01M 8/04007; H01M 8/0438; H01M 8/1004

(52) U.S. Cl. CPC H01M 8/04768; H01M 8/04074; H01M 8/04417; H01M 8/1004

(57) ABSTRACT

A cooling control method includes (a) calculating an actual pump flow rate for each pump, (b) calculating a radiator flow rate using a sum of actual pump flow rates for each pump, (c) calculating a common pressure loss that is a pressure loss for a common flow path, of a refrigerant passage, that is common to fuel cell stacks using the radiator flow rate, (d) calculating an individual pressure loss that is a pressure loss for each individual flow path, of the refrigerant passage, corresponding to each of the fuel cell stacks, and (e) causing each pump to operate using a total pressure loss obtained by summing the common pressure loss and the individual pressure losses and a required pump flow rate for each pump.

### CROSS-REFERENCE TO RELATED APPLICATION

This application claims priority to Japanese Patent Application No. 2024-068907 filed on Apr. 22, 2024, incorporated herein by reference in its entirety.

### BACKGROUND

### 1. Technical Field

The present disclosure relates to a cooling control method and a cooling control device for fuel cell stacks.

### 2. Description of Related Art

Conventionally, there has been known a technique of controlling the rotational speed of each pump in a power system in which a plurality of fuel cell systems including a fuel cell stack and a pump that supplies a coolant to the fuel cell stack are connected in parallel to a single radiator by a cooling passage (Japanese Unexamined Patent Application Publication No. 2022-154531 (JP 2022-154531 A)). In this technique, the rotational speed of the pump is controlled by at least one of cooperative control in which the pumps of the fuel cell systems are caused to operate at a uniform rotational speed and independent control in which the pumps of the fuel cell systems are caused to operate at individually set rotational speeds.

### SUMMARY

In the cooperative control, the rotational speed of each pump is set uniformly. Therefore, it is possible to suppress the control load at the time of setting the rotational speed of the pump compared to the individual control. On the other hand, it may not be possible to supply the refrigerant to each fuel cell stack at a flow rate suitable for the fuel cell stack. In the individual control, the rotational speed of each pump is set individually. Therefore, it is possible to increase the possibility that the refrigerant can be supplied to each fuel cell stack at a flow rate suitable for the fuel cell stack compared to the cooperative control. On the other hand, there is a possibility that the control load at the time of setting the rotational speed of the pump increases.

The present disclosure can be implemented in the following aspects.

(1) An aspect of the present disclosure provides a cooling control method for fuel cell stacks. A cooling control method for a plurality of fuel cell stacks connected in parallel to a common radiator by a refrigerant passage through which a refrigerant flows, the refrigerant passage being provided with a pump for each of the fuel cell stacks to circulate the refrigerant between the fuel cell stack and the radiator, the cooling control method including:
(a) calculating an actual pump flow rate for each of the pumps;
(b) calculating a radiator flow rate using a sum of the actual pump flow rate for each of the pumps;
(c) calculating a common pressure loss that is a pressure loss for a common flow path, of the refrigerant passage, that is common to the fuel cell stacks using the radiator flow rate;
(d) calculating an individual pressure loss that is a pressure loss for each individual flow path, of the refrigerant passage, corresponding to each of the fuel cell stacks; and
(e) causing each of the pumps to operate using a total pressure loss obtained by summing the common pressure loss and the individual pressure losses and a required pump flow rate for each of the pumps.

According to this aspect, the rotational speed of each pump can be individually set and each pump can be caused to operate using the pressure loss at the time when the refrigerant passes through the refrigerant passage and the required pump flow rate for each pump. Consequently, it is possible to increase the possibility that the refrigerant can be supplied to each fuel cell stack at a flow rate suitable for the fuel cell stack as compared with the case where each pump is caused to operate at a uniformly set rotational speed. At this time, the radiator flow rate can be calculated using the sum of the actual pump flow rate for each pump, and the common pressure loss can be calculated using the radiator flow rate. That is, the common pressure loss can be calculated while considering the common flow path as one system common to the fuel cell stacks. Therefore, it is possible to secure the cooling accuracy while reducing the control load at the time of setting the rotational speed of the pump.

(2) In the above aspect,
in (a), the actual pump flow rate may be calculated using a rotational speed of the pump at a specific time point earlier than a time point of calculation of the actual pump flow rate and the total pressure loss at the specific time point. According to this aspect, the actual pump flow rate can be calculated using the rotational speed of the pump at a specific time point earlier than the time point of calculation of the actual pump flow rate and the total pressure loss at the specific time point.

(3) In the above aspect,
in (e), a rotational speed of the pump may be calculated by fitting the total pressure loss and the required pump flow rate to a characteristic map prepared in advance; and the characteristic map may represent a correlation between a pump flow rate, the total pressure loss, and the rotational speed of the pump.

According to this aspect, the rotational speed of the pump can be calculated by fitting the total pressure loss and the required pump flow rate to the characteristic map prepared in advance.

(4) In the above aspect,
in (c), the common pressure loss may be calculated by multiplying the radiator flow rate by a pressure loss coefficient determined in advance; and
in (d), the individual pressure loss may be calculated by multiplying the actual pump flow rate of the corresponding pump by a pressure loss coefficient determined in advance.

According to this aspect, the common pressure loss can be calculated by multiplying the radiator flow rate by a pressure loss coefficient determined in advance. In addition, the individual pressure loss can be calculated by multiplying the actual pump flow rate of the corresponding pump by a pressure loss coefficient determined in advance.

(5) Another aspect of the present disclosure provides a cooling control device for fuel cell stacks. A cooling control device for a plurality of fuel cell stacks connected in parallel to a common radiator by a refrigerant passage through which a refrigerant flows,
the refrigerant passage being provided with a pump for each of the fuel cell stacks to circulate the refrigerant between the fuel cell stack and the radiator,
the cooling control device including:
an actual flow rate calculation unit that calculates an actual pump flow rate for each of the pumps;
a radiator flow rate calculation unit that calculates a radiator flow rate using a sum of the actual pump flow rate for each pump;
a common pressure loss calculation unit that calculates a common pressure loss that is a pressure loss for a common flow path, of the refrigerant passage, that is common to the fuel cell stacks using the radiator flow rate;
an individual pressure loss calculation unit that calculates an individual pressure loss that is a pressure loss for each individual flow path, of the refrigerant passage, corresponding to each of the fuel cell stacks; and
an operation control unit that causes each pump to operate using a total pressure loss obtained by summing the common pressure loss and the individual pressure losses and a required pump flow rate for each pump.

According to this aspect, the cooling control device can individually set the rotational speed of each pump and cause each pump to operate using the pressure loss at the time when the refrigerant passes through the refrigerant passage and the required pump flow rate for each pump. Consequently, it is possible to increase the possibility that the refrigerant can be supplied to each fuel cell stack at a flow rate suitable for the fuel cell stack as compared with the case where each pump is caused to operate at a uniformly set rotational speed. At this time, the cooling control device can calculate the radiator flow rate using the sum of the actual pump flow rate for each pump, and calculate the common pressure loss using the radiator flow rate. That is, the cooling control device can calculate the common pressure loss while considering the common flow path as one system common to the fuel cell stacks. Therefore, it is possible to secure the cooling accuracy while reducing the control load at the time of setting the rotational speed of the pump.

The present disclosure can be implemented in various forms other than the above cooling control method and cooling control device for fuel cell stacks. For example, the present disclosure can be implemented in the form of a cooling system including a cooling device and a cooling control device, a method of manufacturing a cooling control device and a cooling system, a method of controlling a cooling control device and a cooling system, a computer program that implements the control method, a non-transitory storage medium storing the computer program, etc.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a cooling system;

FIG. 2 is a block diagram illustrating a configuration of a cooling control device;

FIG. 3 is a conceptual diagram of a characteristic map; and

FIG. 4 is a flowchart illustrating a cooling control method of a fuel cell stack.

### DETAILED DESCRIPTION OF EMBODIMENTS

### A. Embodiment

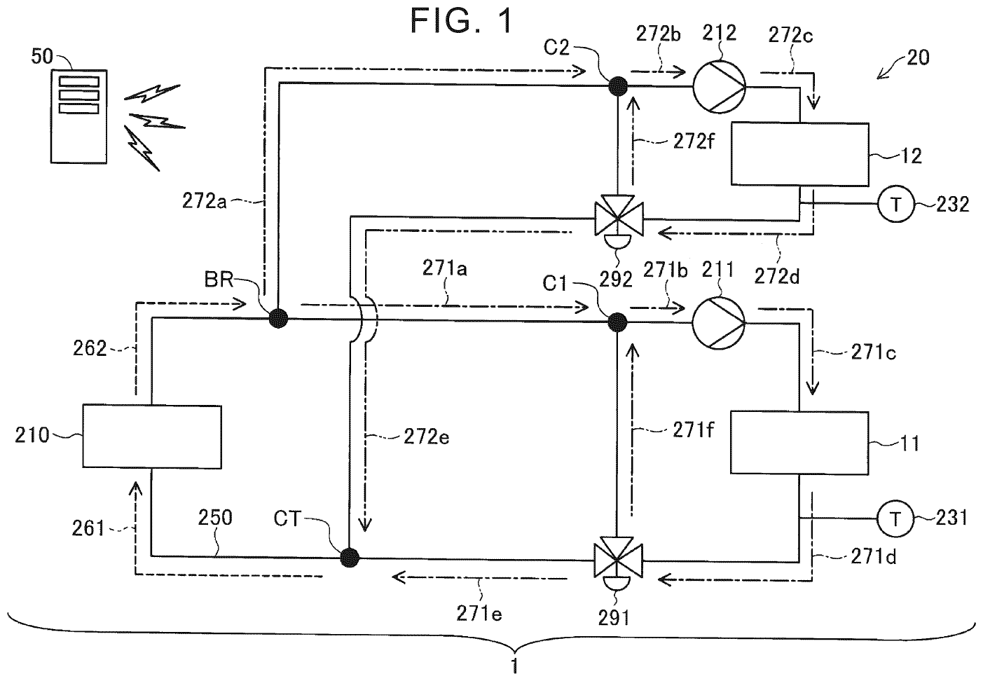

FIG. 1 is a diagram illustrating a configuration of a cooling system 1. The cooling system 1 is a system for cooling fuel cell stacks 11, 12. The fuel cell stacks 11, 12 have a stack structure in which a plurality of single cells are stacked. The single cell includes a membrane electrode assembly (MEA) in which an electrolyte membrane, an anode formed on one surface of the electrolyte membrane, and a cathode formed on the other surface of the electrolyte membrane are bonded, and a pair of separators that sandwich the membrane electrode assembly from both sides. The fuel cell stacks 11, 12 supply hydrogen to the anode and air to the cathode, thereby generating electricity through an electrochemical reaction. The cooling system 1 includes a cooling device 20 and a cooling control device 50.

The cooling device 20 circulates and supplies a refrigerant to the fuel cell stacks 11, 12 to cool the fuel cell stacks 11, 12. The cooling device 20 includes a radiator 210, two pumps 211, 212, two temperature sensors 231, 232, a refrigerant passage 250, and two rotary valves 291, 292.

The radiator 210 cools the refrigerant discharged from the fuel cell stacks 11, 12 by heat exchange. In the present embodiment, the first fuel cell stack 11 and the second fuel cell stack 12 are connected in parallel to one common radiator 210 by the refrigerant passage 250.

The pumps 211, 212 are provided for the respective fuel cell stacks 11, 12. The first pump 211 circulates the refrigerant between the first fuel cell stack 11 and the radiator 210. The second pump 212 circulates the refrigerant between the second fuel cell stack 12 and the radiator 210.

The temperature sensors 231, 232 are provided for the respective fuel cell stacks 11, 12. The first temperature sensor 231 measures the temperature of the refrigerant discharged from the first fuel cell stack 11 and outputs the result to the cooling control device 50. The second temperature sensor 232 measures the temperature of the refrigerant discharged from the second fuel cell stack 12 and outputs the result to the cooling control device 50.

The refrigerant passage 250 allows the refrigerant to flow therethrough. In FIG. 1, flow directions of the refrigerant are indicated by arrows. The refrigerant passage 250 has common flow paths 261, 262 and individual flow paths 271a to 271f, 272a to 272f.

The common flow paths 261, 262 are flow paths common to the two fuel cell stacks 11, 12 in the refrigerant passage 250. In FIG. 1, the common flow paths 261, 262 are indicated by broken lines. The first common flow path 261 is a flow path for supplying the refrigerant to the radiator 210 from the main merging point CT, which is a merging point of the refrigerant discharged from the fuel cell stacks 11, 12. The second common flow path 262 is a flow path for supplying the refrigerant from the radiator 210 to the branch point BR branching from the first individual flow paths 271a to 271f and the second individual flow paths 272a to 272f.

The individual flow paths 271a to 271f, 272a to 272f are flow paths corresponding to the respective two fuel cell stacks 11, 12. The first individual flow paths 271a to 271f are individual flow paths corresponding to the first fuel cell stack 11. In FIG. 1, the first individual flow paths 271a to 271f are indicated by dashed-dotted lines. The second individual flow paths 272a to 272f are individual flow paths corresponding to the second fuel cell stack 12. In FIG. 1, the second individual flow paths 272a to 272f are indicated by two-dot chain lines. The individual flow paths 271a to 271f include five main flow paths 271a to 271e, and a sub-flow path 271f. The individual flow paths 272a to 272f include five main flow paths 272a to 272e, and a sub-flow path 272f. The first main flow paths 271a, 272a are flow paths for supplying the refrigerant from the branch point BR to the sub-merging points C1, C2, respectively, which are respective merging points with the sub-flow paths 271f, 272f. The second main flow paths 271b, 272b are flow paths for supplying the refrigerant from the sub-merging points C1, C2 to the pumps 211, 212, respectively. The third main flow paths 271c, 272c are flow paths for supplying the refrigerant from the pumps 211, 212 to the fuel cell stacks 11, 12, respectively. The fourth main flow paths 271d, 272d are flow paths for supplying the refrigerant from the fuel cell stacks 11, 12 to the rotary valves 291, 292, respectively. The fifth main flow paths 271e, 272e are flow paths for supplying the refrigerant from the rotary valves 291, 292, respectively, to the main merging point CT. The sub-flow paths 271f, 272f are flow paths for supplying the refrigerant from the rotary valves 291, 292 to the sub-merging points C1, C2, respectively, without passing through the radiator 210.

The rotary valves 291, 292 are three-way valves that switch the flow path of the refrigerant between respective circulation paths through the fuel cell stacks 11, 12 and the radiator 210 and respective bypass paths through the fuel cell stacks 11, 12 without passing through the radiator 210. The circulation paths are paths formed by the common flow paths 261, 262, the first main flow paths 271a, 272a, the second main flow paths 271b, 272b, the third main flow paths 271c, 272c, the fourth main flow paths 271d, 272d, and the fifth main flow paths 271e, 272e. The bypass paths are paths formed by the sub-flow paths 271f, 272f, the second main flow paths 271b, 272b, the third main flow paths 271c, 272c, and the fourth main flow paths 271d, 272d. The first rotary valve 291 adjusts the flow ratio between a flow of the refrigerant supplied from the fourth main flow path 271d to the fifth main flow path 271e, among the first individual flow paths 271a to 271f, and a flow rate of the refrigerant supplied from the fourth main flow path 271d to the sub-flow path 271f. The second rotary valve 292 adjusts the flow ratio between a flow rate of the refrigerant supplied from the fourth main flow path 272d to the fifth main flow path 272e, among the second individual flow paths 272a to 272f, and a flow rate of the refrigerant supplied from the fourth main flow path 272d to the sub-flow path 272f.

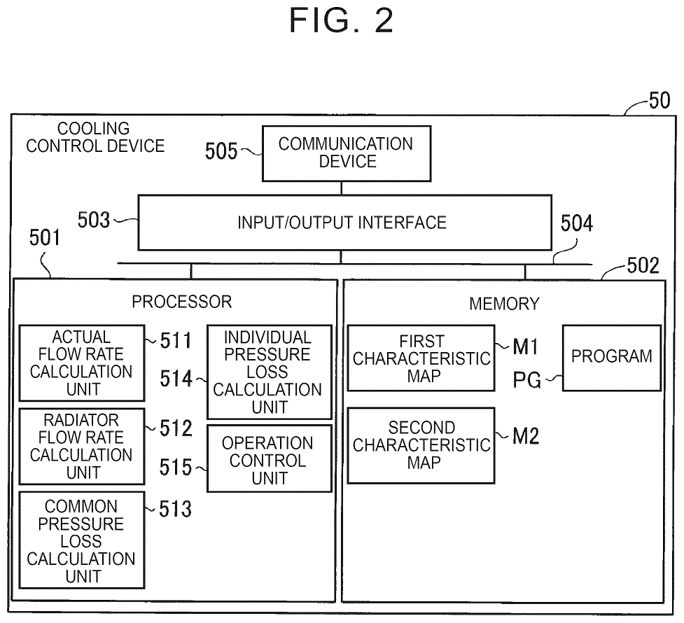

FIG. 2 is a block diagram illustrating a configuration of the cooling control device 50. The cooling control device 50 controls the operation of the cooling device 20. The cooling control device 50 includes a processor 501, a memory 502, an input/output interface 503, and a bus 504. The processor 501, the memory 502, and the input/output interface 503 are connected via a bus 504 so as to be capable of bidirectional communication. A communication device 505 for communicating with the cooling device 20 is connected to the input/output interface 503. The communication device 505 can communicate with the cooling device 20 by wired communication or wireless communication.

The processor 501 executes a program PG stored in the memory 502, thereby functioning as an actual flow rate calculation unit 511, a radiator flow rate calculation unit 512, a common pressure loss calculation unit 513, an individual pressure loss calculation unit 514, and an operation control unit 515.

The actual flow rate calculation unit 511 calculates an actual pump flow rate for each of the pumps 211, 212. The actual pump flow rate is the amount of refrigerant actually discharged from each of the pumps 211, 212 per unit time.

The radiator flow rate calculation unit 512 calculates a radiator flow rate by using the sum of the actual pump flow rates for the pumps 211, 212. The radiator flow rate is the amount of refrigerant that passes through the radiator 210 per unit time.

The common pressure loss calculation unit 513 calculates a common pressure loss by using the radiator flow rate. The common pressure loss is the pressure loss for the common flow paths 261, 262.

The individual pressure loss calculation unit 514 calculates an individual pressure loss for each of the fuel cell stacks 11, 12. The individual pressure losses are pressure losses associated with the respective individual flow paths 271a to 271f, 272a to 272f for the respective two fuel cell stacks 11, 12.

The operation control unit 515 operates each of the pumps 211, 212 using a total pressure loss and a required pump flow rate for each of the pumps 211, 212. The total pressure loss is a pressure loss calculated by summing the common pressure loss and the individual pressure losses for the individual flow paths 271a to 271f, 272a to 272f for the respective fuel cell stacks 11, 12 corresponding to the respective target pumps 211, 212. The required pump flow rate is an amount of refrigerant required to be discharged from each of the pumps 211, 212 per unit time.

The fuel cell stacks 11, 12 are cooled to a desired temperature by adjusting at least one of the flow rates of the pumps 211, 212 determined by the rotational speeds of the pumps 211, 212 and the heads of the pumps 211, 212 and the opening degrees of the rotary valves 291, 292. That is, the rotational speeds of the pumps 211, 212, the heads of the pumps 211, 212, the flow rates of the pumps 211, 212, and the opening degrees of the rotary valves 291, 292 have a correlation. Therefore, characteristic maps M1, M2 indicating a correlation between the rotational speeds of the pumps 211, 212, the heads of the pumps 211, 212, the flow rates of the pumps 211, 212, and the opening degrees of the rotary valves 291, 292 are prepared in advance, so that the following can be performed. When at least one of the rotational speeds of the pumps 211, 212, the heads of the pumps 211, 212, the flow rates of the pumps 211, 212, and the opening degrees of the rotary valves 291, 292 is an unknown number, the unknown number can be calculated by applying a known number to the characteristic maps M1, M2.

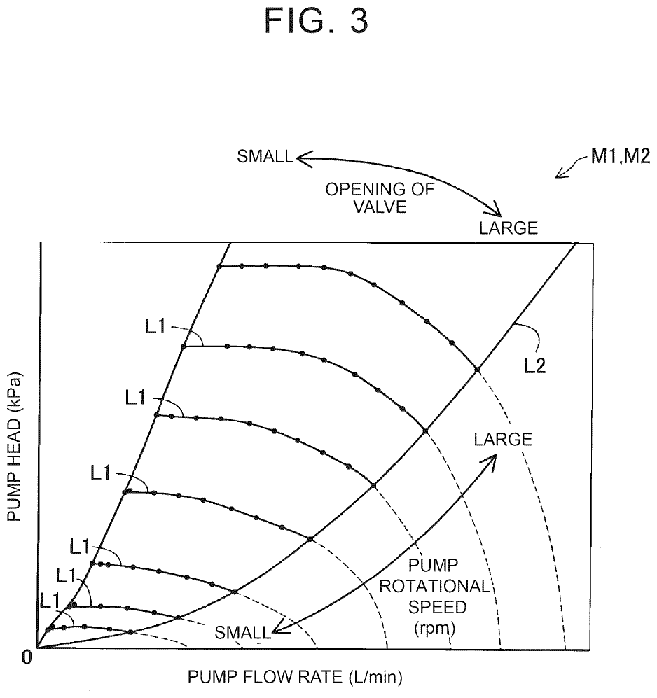

FIG. 3 is a conceptual diagram of the characteristic maps M1, M2. The vertical axis of FIG. 3 shows the pump head. The horizontal axis in FIG. 3 indicates the pump flow rate. An equal rotational speed L1 indicates a correlation between the pump head and the pump flow rate when the rotational speeds of the pumps 211, 212 are kept constant and the opening degrees of the rotary valves 291, 292 are changed. An equal opening degree L2 indicates a correlation between the pump head and the pump flow rate when the opening degrees of the rotary valves 291, 292 are made constant and the rotational speeds of the pumps 211, 212 are changed. The characteristic maps M1, M2 are prepared in advance for the pumps 211, 212, respectively, and stored in the memory 502 shown in FIG. 1. The first characteristic map M1 represents an operating characteristic of the first pump 211. The second characteristic map M2 represents an operating characteristic of the second pump 212.

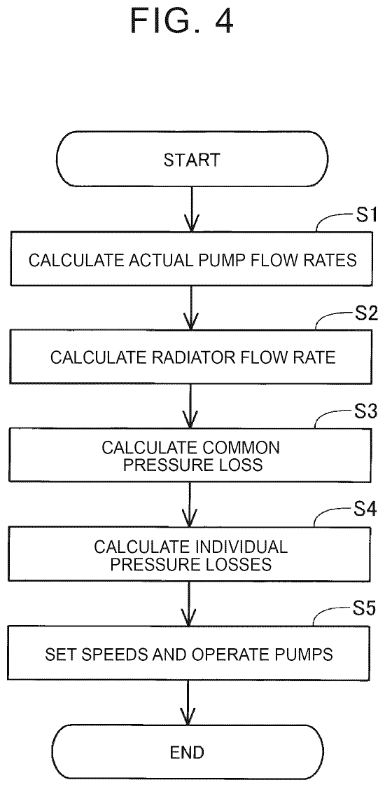

FIG. 4 is a flowchart showing a cooling control method for two fuel cell stacks 11, 12 connected in parallel to the common radiator 210 by the refrigerant passage 250. The flow illustrated in FIG. 4 is repeatedly executed at a predetermined cycle in a period in which power is generated using the fuel cell stacks 11, 12, for example.

In S1, the actual flow rate calculation unit 511 calculates each of the actual pump flow rate for the first pump 211 and the actual pump flow rate for the second pump 212. Here, the heads of the pumps 211, 212 are pressure differences obtained by subtracting respective inflow pressures when the refrigerant flows into the pumps 211, 212 from respective discharge pressures when the refrigerant is discharged from the pumps 211, 212, and are equal to the total pressure loss. Therefore, the actual flow rate calculation unit 511 applies the rotational speed of the first pump 211 at a specific time point prior to the calculation time point of the actual pump flow rate, the total pressure loss for the first fuel cell stack 11 at the specific time point, and the opening degree of the first rotary valve 291 at the specific time point to the first characteristic map M1. Thus, the actual flow rate calculation unit 511 calculates the actual pump flow rate for the first pump 211. Similarly, the actual flow rate calculation unit 511 applies the rotational speed of the second pump 212 at the specific time point, the total pressure loss for the second fuel cell stack 12 at the specific time point, and the opening degree of the second rotary valve 292 at the specific time point to the second characteristic map M2. Thus, the actual flow rate calculation unit 511 calculates the actual pump flow rate for the second pump 212. The rotational speed of each of the pumps 211, 212 is measured by, for example, a sensor (not shown) and is output to the cooling control device 50. The total pressure losses at the specific time point are, for example, previous values of the total pressure losses for the target fuel cell stacks 11, 12. The previous value of the total pressure loss is a value of the total pressure loss calculated at the previous control timing in S5 described later. In the case where the flow shown in FIG. 4 is executed for the first time, since the pumps 211, 212 are not rotating, the total pressure loss at the specific time point is zero.

In S2, the radiator flow rate calculation unit 512 calculates the radiator flow rate. As shown in FIG. 1, the refrigerant discharged from the first fuel cell stack 11 and the refrigerant discharged from the second fuel cell stack 12 flow into the radiator 210. Therefore, the radiator flow rate calculation unit 512 calculates the sum of the actual pump flow rate for the first pump 211 and the actual pump flow rate for the second pump 212 as the radiator flow rate.

In S3, the common pressure loss calculation unit 513 calculates the common pressure loss. Here, the dynamic pressure and the pressure loss indicating the kinetic energy of the refrigerant per unit area have a correlation. The dynamic pressure is proportional to the density of the refrigerant and the flow rate of the refrigerant. The flow rate of the refrigerant and the flow velocity of the refrigerant have a correlation. Therefore, the pressure loss can be calculated by multiplying the flow rate of the refrigerant by a predetermined pressure loss coefficient. Pressure loss occurs each time the refrigerant passes through each of the flow paths 261, 262, 271a to 271f, 272a to 272f, and each of the devices 11, 12, 210, 211, 212, 291, 292. Therefore, the common pressure loss calculation unit 513 multiplies the radiator flow rate by a pressure loss coefficient corresponding to the first common flow path 261 to calculate the pressure loss that occurs when the refrigerant passes through the first common flow path 261. The common pressure loss calculation unit 513 multiplies the radiator flow rate by a pressure loss coefficient corresponding to the radiator 210 to calculate the pressure loss generated when the refrigerant passes through the radiator 210. The common pressure loss calculation unit 513 multiplies the radiator flow rate by a pressure loss coefficient corresponding to the second common flow path 262 to calculate the pressure loss generated when the refrigerant passes through the second common flow path 262. Then, the common pressure loss calculation unit 513 sums the pressure losses generated when the refrigerant passes through the common flow paths 261, 262 and the pressure loss generated when the refrigerant passes through the radiator 210 to obtain the common pressure loss. When the refrigerant is flowing in the sub-flow paths 271f, 272f, the common pressure loss calculation unit 513 calculates the common pressure loss in consideration of the opening degrees of the rotary valves 291, 292.

In S4, the individual pressure loss calculation unit 514 calculates each of the individual pressure loss for the first individual flow paths 271a to 271f and the individual pressure loss for the second individual flow paths 272a to 272f. The individual pressure loss calculation unit 514 multiplies the actual pump flow rate of the first pump 211 by a pressure loss coefficient corresponding to the first main flow path 271a to calculate the pressure loss that occurs when the refrigerant passes through the first main flow path 271a. The individual pressure loss calculation unit 514 multiplies the actual pump flow rate of the first pump 211 by a pressure loss coefficient corresponding to the second main flow path 271b to calculate the pressure loss that occurs when the refrigerant passes through the second main flow path 271b. The individual pressure loss calculation unit 514 multiplies the actual pump flow rate of the first pump 211 by a pressure loss coefficient corresponding to the first pump 211 to calculate the pressure loss that occurs when the refrigerant passes through the first pump 211. The individual pressure loss calculation unit 514 multiplies the actual pump flow rate of the first pump 211 by a pressure loss coefficient corresponding to the third main flow path 271c to calculate the pressure loss that occurs when the refrigerant passes through the third main flow path 271c. The individual pressure loss calculation unit 514 multiplies the actual pump flow rate of the first pump 211 by a pressure loss coefficient corresponding to the first fuel cell stack 11 to calculate the pressure loss generated when the refrigerant passes through the first fuel cell stack 11. The individual pressure loss calculation unit 514 multiplies the actual pump flow rate of the first pump 211 by a pressure loss coefficient corresponding to the fourth main flow path 271d to calculate the pressure loss that occurs when the refrigerant passes through the fourth main flow path 271d. The individual pressure loss calculation unit 514 multiplies the actual pump flow rate of the first pump 211 by a pressure loss coefficient corresponding to the first rotary valve 291 to calculate the pressure loss that occurs when the refrigerant passes through the first rotary valve 291. The individual pressure loss calculation unit 514 multiplies the actual pump flow rate of the first pump 211 by a pressure loss coefficient corresponding to the fifth main flow path 271e to calculate the pressure loss that occurs when the refrigerant passes through the fifth main flow path 271e. The individual pressure loss calculation unit 514 multiplies the actual pump flow rate of the first pump 211 by a pressure loss coefficient corresponding to the sub-flow path 271f to calculate the pressure loss that occurs when the refrigerant passes through the sub-flow path 271f. Then, the individual pressure loss calculation unit 514 sums the pressure losses generated when the refrigerant passes through the first individual flow paths 271a to 271f and the pressure losses generated when the refrigerant passes through the respective devices 11, 211, 291 to obtain the individual pressure loss for the first individual flow paths 271a to 271f. Similarly, the individual pressure loss calculation unit 514 sums the pressure losses generated when the refrigerant passes through the second individual flow paths 272a to 272f and the pressure losses generated when the refrigerant passes through the respective devices 12, 212, 292 to obtain the individual pressure loss for the second individual flow paths 272a to 272f. When the refrigerant is flowing in the sub-flow paths 271f, 272f, the individual pressure loss calculation unit 514 calculates the individual pressure losses in consideration of the opening degrees of the rotary valves 291, 292.

In S5, the operation control unit 515 sets each of the rotational speed of the first pump 211 and the rotational speed of the second pump 212, and operates the respective pumps 211, 212 according to the set rotational speeds. The operation control unit 515 applies the total pressure loss obtained by summing the common pressure loss and the individual pressure loss for the first individual flow paths 271a to 271f, the required pump flow rate of the first pump 211, and the opening degree of the first rotary valve 291 to the first characteristic map M1. Thus, the operation control unit 515 calculates and sets the rotational speed of the first pump 211. The operation control unit 515 applies the total pressure loss obtained by summing the common pressure loss and the individual pressure loss for the second individual flow paths 272a to 272f, the required pump flow rate of the second pump 212, and the opening degree of the second rotary valve 292 to the second characteristic map M2. Thus, the operation control unit 515 calculates and sets the rotational speed of the second pump 212. The required pump flow rates are determined in accordance with the respective temperatures of the fuel cell stacks 11, 12. Therefore, for example, the operation control unit 515 calculates an estimated value of the temperature of the refrigerant discharged from each of the fuel cell stacks 11, 12 by subtracting the amount of heat dissipation to the outside of the piping constituting the refrigerant passage 250 from the temperature of the refrigerant output from a corresponding one of the temperature sensors 231, 232. Then, the operation control unit 515 determines the required pump flow rate based on the estimated value of the temperature of the refrigerant.

According to the above-described embodiment, the cooling control device 50 can operate by individually setting the rotational speed of each of the pumps 211, 212 using the pressure loss when the refrigerant passes through the refrigerant passage 250 and the required pump flow rate for each of the pumps 211, 212. As a result, it is possible to increase the possibility that the refrigerant having a flow rate suitable for each of the fuel cell stacks 11, 12 can be supplied to each of the fuel cell stacks 11, 12 as compared with the case where the rotational speeds of the pumps 211, 212 are uniformly set and and the pumps 211, 212 are operated. At this time, the cooling control device 50 can calculate the radiator flow rate using the sum of the actual pump flow rates for the respective pumps 211, 212, and can calculate the common pressure loss using the radiator flow rate. That is, the cooling control device 50 can calculate the common pressure loss since the common flow paths 261, 262 are considered as one system common to the two fuel cell stacks 11, 12. Therefore, it is possible to secure cooling accuracy while reducing the control load when the rotational speeds of the pumps 211, 212 are set.

Further, according to the above-described embodiment, the cooling control device 50 can calculate the actual pump flow rates using the rotational speeds of the pumps 211, 212 at the specific time point before the calculation time point of the actual pump flow rates and the total pressure losses at the specific time point. The cooling control device 50 can calculate the rotational speeds of the pumps 211, 212 by applying the total pressure losses and the required pump flow rates to the characteristic maps M1, M2 prepared in advance. The cooling control device 50 can calculate the common pressure loss by multiplying the radiator flow rate by the predetermined pressure loss coefficient. The cooling control device 50 can calculate the individual pressure losses by multiplying the actual pump flow rates of the respective pumps 211, 212 by the respective predetermined pressure loss coefficients.

### B. Other Embodiments

(B1) The cooling control device 50 may control the cooling of one of the fuel cell stacks 11, 12 among a plurality of the fuel cell stacks 11, 12 connected to the common radiator 210 by the refrigerant passage 250. In this case, the cooling control device 50 calculates the common pressure loss since the actual pump flow rate of one of the pumps 211, 212 provided for a corresponding one of the target fuel cell stacks 11, 12 is considered as the radiator flow rate. With this configuration, the cooling control device 50 can control the cooling of any one of the fuel cell stacks 11, 12 among the fuel cell stacks 11, 12 connected to the common radiator 210 by the refrigerant passage 250.

(B2) The cooling control device 50 may control the cooling of three or more fuel cell stacks 11, 12 connected in parallel to the common radiator 210 by the refrigerant passage 250. In this case, the cooling control device 50 calculates the common pressure loss using the sum of the actual pump flow rates of all the pumps 211, 212 provided for all the target fuel cell stacks 11, 12 as the radiator flow rate. With this configuration, the cooling control device 50 can control the cooling of three or more fuel cell stacks 11, 12 connected in parallel to the common radiator 210 by the refrigerant passage 250.

(B3) The cooling control device 50 may calculate the actual pump flow rate of each of the pumps 211, 212, the rotational speed of each of the pumps 211, 212, the common pressure loss, and the individual pressure losses by methods other than those described above. The cooling control device 50 may calculate the rotational speeds of the pumps 211, 212 using, for example, a table or a relational expression indicating a correlation between the rotational speeds of the pumps 211, 212, the heads of the pumps 211, 212, the flow rates of the pumps 211, 212, and the opening degrees of the rotary valves 291, 292.

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve some or all of the above issues or to achieve some or all of the above effects. When the technical features are not described as essential in this specification, the technical features can be deleted as appropriate.

What is claimed is:

1. A cooling control method for a plurality of fuel cell stacks connected in parallel to a common radiator by a refrigerant passage through which a refrigerant flows, the refrigerant passage being provided with a pump for each of the fuel cell stacks to circulate the refrigerant between the fuel cell stack and the radiator, the cooling control method comprising:
(a) calculating an actual pump flow rate for each of the pumps;
(b) calculating a radiator flow rate using a sum of the actual pump flow rate for each of pumps;
(c) calculating a common pressure loss that is a pressure loss for a common flow path, of the refrigerant passage, that is common to the fuel cell stacks using the radiator flow rate;
(d) calculating an individual pressure loss that is a pressure loss for each individual flow path, of the refrigerant passage, corresponding to each of the fuel cell stacks; and
(e) causing each of the pumps to operate using a total pressure loss obtained by summing the common pressure loss and the individual pressure losses and a required pump flow rate for each of the pumps.

2. The cooling control method according to claim 1, wherein in (a), the actual pump flow rate is calculated using a rotational speed of the pump at a specific time point earlier than a time point of calculation of the actual pump flow rate and the total pressure loss at the specific time point.

3. The cooling control method according to claim 1, wherein:
in (e), a rotational speed of the pump is calculated by fitting the total pressure loss and the required pump flow rate to a characteristic map prepared in advance; and
the characteristic map represents a correlation between a pump flow rate, the total pressure loss, and the rotational speed of the pump.

4. The cooling control method according to claim 1, wherein:
in (c), the common pressure loss is calculated by multiplying the radiator flow rate by a pressure loss coefficient determined in advance; and
in (d), the individual pressure loss is calculated by multiplying the actual pump flow rate of the corresponding pump by a pressure loss coefficient determined in advance.

5. A cooling control device for a plurality of fuel cell stacks connected in parallel to a common radiator by a refrigerant passage through which a refrigerant flows, the refrigerant passage being provided with a pump for each of the fuel cell stacks to circulate the refrigerant between the fuel cell stack and the radiator, the cooling control device comprising:
an actual flow rate calculation unit that calculates an actual pump flow rate for each of the pumps;
a radiator flow rate calculation unit that calculates a radiator flow rate using a sum of the actual pump flow rate for each pump;
a common pressure loss calculation unit that calculates a common pressure loss that is a pressure loss for a common flow path, of the refrigerant passage, that is common to the fuel cell stacks using the radiator flow rate;
an individual pressure loss calculation unit that calculates an individual pressure loss that is a pressure loss for each individual flow path, of the refrigerant passage, corresponding to each of the fuel cell stacks; and
an operation control unit that causes each pump to operate using a total pressure loss obtained by summing the common pressure loss and the individual pressure losses and a required pump flow rate for each pump.
